(19) United States
(12) Patent Application Publication
(10) Pub. No.: US 2017/0104381 A1
(43) Pub. Date: Apr. 13, 2017

(54) Isothermal Support And Vacuum Container For Superconducting Windings In Rotary Machines

(71) Applicant: Siemens Aktiengesellschaft, Muenchen (DE)

(72) Inventors: Otto Batz, Leutenbach (DE); Anne Bauer, Fuerth (DE); Dietmar Bayer, Heroldsbach (DE); Michael Frank, Uttenreuth (DE); Joern Grundmann, Grossenseebach (DE); Peter Kummeth, Herzogenaurach (DE); Peter van Hasselt, Erlangen (DE)

(73) Assignee: Siemens Aktiengesellschaft, Muenchen (DE)

(21) Appl. No.: 15/314,122

(22) PCT Filed: Mar. 24, 2015
(86) PCT No.: PCT/EP2015/056280

§ 371 Date: Nov. 28, 2016

(30) Foreign Application Priority Data
May 28, 2014 (DE) 10 2014 210 191.3

(51) Int. Cl. H02K 3/34; H02K 3/24; H02K 55/04; H02K 3/51; H01F 6/06; H02K 9/20; H02K 3/30

(52) U.S. Cl. CPC H02K 3/345; H02K 9/20; H02K 3/24; H02K 3/30; H02K 3/51; H01F 6/06; H02K 55/04

(57) ABSTRACT

A rotary machine, e.g., a synchronous machine, may include cold superconducting windings arranged in a warm soft-magnetic rotor body. Two adjacent windings may be arranged between every two adjacent soft-magnetic pole bodies and fastened by support elements in a common pair of vacuum containers in order to achieve thermal insulation. The two windings may be isothermally interconnected at their mutually facing sides by at least one common support and/or traction element.

### CROSS-REFERENCE TO RELATED APPLICATIONS

This application is a U.S. National Stage application of International Application No. PCT/EP2015/056280 filed Mar. 24, 2015, which designates the United States of America, and claims priority to DE Application No. 10 2014 210 0.3 filed. May 28, 2014, the contents of which are hereby incorporated by reference in their entirety.

### TECHNICAL FIELD

The present invention relates to a rotary machine according to the preamble of the main claim, and to a method for the production thereof according to the preamble of the first further independent claims, and to associated methods for cooling a corresponding rotary machine.

### BACKGROUND

When cryogenic or cold superconducting windings are used in rotary machines, in particular synchronous generators or synchronous motors, with warm motor iron, it is basically necessary to accommodate each winding in a vacuum vessel in order to permit sufficiently good thermal insulation in the first place. The forces acting on the winding in the respective application have to be reliably transmitted from the cold winding to the warm vacuum container wall, which is at room temperature or there above. Such acting forces may be, for example, magnetic forces or centrifugal forces, or may also occur in the event of malfunctions, which have to be taken into consideration.

Materials which are thermally poor conductors are therefore conventionally used for corresponding support or traction elements between an individual winding and the vacuum casing thereof. Such materials may be, for example, titanium or, preferably, glass fiber reinforced plastics (GFRP). A required material cross section of said support or traction elements, and accordingly the undesired heat conduction, is ultimately scaled with the magnitude of the forces which have to be supported relative to the warm wall.

### SUMMARY

One embodiment provides a rotary machine, comprising: a warm soft-magnetic rotor body including a plurality of soft-magnetic pole bodies, a plurality of cold superconducting windings, wherein a pair of the windings are positioned adjacent to each other between each adjacent pair of soft-magnetic pole bodies, wherein each pair of windings is fastened by support elements in a common pair of vacuum containers to provide thermal insulation, and wherein each pair of windings are isothermally connected to each other at mutually facing sides by at least one common support or at least one traction element.

In one embodiment, instead of the pairs of vacuum containers, the machine include a common overall vacuum container enclosing all of the pairs of vacuum container volumes and additionally at least parts of the soft-magnetic rotor body.

In one embodiment, the respective pair of vacuum containers has been produced by means of formation of at least one vacuum-tight connecting channel between originally two individual vacuum containers each surrounding a winding, wherein a connecting channel in each case receives at least one common support and/or traction element.

In one embodiment, the respective pair of vacuum containers has been produced by means of removal of two intermediate walls between originally two individual vacuum containers each surrounding a winding, wherein the two resulting vacuum container parts have been connected to each other in a vacuum-tight manner.

In one embodiment, the overall vacuum container is designed in the form of a hollow cylinder which has an outer wall and an inner wall and is closed in the region of its basic surfaces by means of annular covers.

In one embodiment, the radius of the outer wall of the hollow cylinder corresponds to an outer radius of the pair of vacuum containers.

In one embodiment, the radius of the outer wall of the hollow cylinder corresponds to an outer radius of the pole bodies of the rotor body.

In one embodiment, the radius of the inner wall of the hollow cylinder corresponds to an inner radius of the pair of vacuum containers.

In one embodiment, the radius of the inner wall of the hollow cylinder corresponds to an inner radius of a carrying body of the rotor body.

In one embodiment, the heat generated by those regions of the soft-magnetic rotor body which are enclosed in the overall vacuum container is dissipated to the inner wall of the hollow cylinder by means of heat conduction and/or heat radiation.

In one embodiment, the heat generated by those regions of the soft-magnetic rotor body which are enclosed in the overall vacuum container is dissipated from the outer wall of the hollow cylinder by means of air cooling.

In one embodiment, the heat generated by those regions of the soft-magnetic rotor body which are enclosed in the overall vacuum container is dissipated by means of a closed circuit cooling which is arranged on the rotor body and has coolant in pipes reaching to the regions.

In one embodiment, the material of the overall vacuum chamber bordering the region of the soft-magnetic rotor body is magnetic.

Another embodiment provides a method for producing a rotary machine, in particular a synchronous machine, with cold superconducting windings positioned in a warm soft-magnetic rotor body, wherein two windings positioned adjacently to each other between every two adjacent soft-magnetic pole bodies are fastened by means of support elements in a common pair of vacuum containers in order to achieve thermal insulation, and the two windings are isothermally connected to each other at their two mutually facing sides by means of at least one common support and/or traction element.

In one embodiment, all of the pairs of vacuum containers are replaced by a common overall vacuum container by the latter enclosing all of the pairs of vacuum container volumes and additionally at least parts of the soft-magnetic rotor body.

In one embodiment, the respective pair of vacuum containers is produced by means of formation of at least one vacuum-tight connecting channel between originally two individual vacuum containers each surrounding a winding, wherein a connecting channel in each case receives at least one common support and/or traction element.

In one embodiment, the respective pair of vacuum containers is produced by means of removal of two intermediate walls between originally two individual vacuum containers each surrounding a winding, wherein the two resulting vacuum container parts are connected to each other in a vacuum-tight manner.

In one embodiment, the overall vacuum container is designed in the form of a hollow cylinder which has an outer wall and an inner wall and is closed in the region of its basic surfaces by means of annular covers.

Another embodiment provides a method for operating a rotary machine, wherein the heat generated by regions of a soft-magnetic rotor body that are enclosed in an overall vacuum container is dissipated to an inner wall of a hollow cylinder by means of heat conduction and/or heat radiation.

In one embodiment, the heat generated by those regions of the soft-magnetic rotor body which are enclosed in the overall vacuum container is dissipated from an outer wall of the hollow cylinder by means of air cooling.

In one embodiment, the heat generated by those regions of the soft-magnetic rotor body which are enclosed in the overall vacuum container is dissipated by means of a closed circuit cooling which is arranged on the rotor body and has coolant in pipes reaching to the regions.

### BRIEF DESCRIPTION OF THE DRAWINGS

Example aspects and embodiments of the invention are described below with reference to the figures, in which:

FIG. 1 shows an exemplary embodiment of a conventional rotary machine, wherein FIG. 1b illustrates an enlarged illustration of two individual vacuum containers of a cross section according to FIG. 1a;

FIG. 2a shows a first exemplary embodiment of a rotary machine according to the invention in cross section;

FIG. 2b shows an enlargement with respect to FIG. 2a;

FIG. 3 shows a second exemplary embodiment of a rotary machine according to the invention;

FIG. 4 shows an illustration of an overall vacuum container according to the invention;

FIG. 5 shows an exemplary embodiment of a production method according to the invention;

FIG. 6 shows an illustration of a cooling method according to the invention.

### DETAILED DESCRIPTION

Embodiments of the invention provide a rotary machine, e.g., a synchronous machine, with cold superconducting windings, which are each positioned in a vacuum container in a warm soft-magnetic rotor body in order to achieve thermal insulation, to reliably transmit forces acting on a respective winding in a respective application from the winding to a warm wall of a respective vacuum container. Furthermore, the intention is to effectively simplify the design of the vacuum containers.

Some embodiments provide a rotary machine, e.g., a synchronous machine, with cold superconducting windings positioned in a warm soft-magnetic rotor body, wherein at least two windings positioned adjacently to each other between every two adjacent soft-magnetic pole bodies are fastened by means of support elements in a common pair of vacuum containers in order to achieve thermal insulation, and the at least two windings are isothermally connected to each other at their two mutually facing sides by means of at least one common support and/or traction element.

The superconducting windings can be referred to as “cold” and the soft-magnetic rotor body and the wall of the vacuum container can be referred to as “warm”. “Cold” here signifies having a temperature in the vicinity of the operating temperature of the superconductor and “warm” here signifies having a temperature greater than or equal to room temperature.

Connect isothermally signifies here in particular that two elements, specifically in particular windings here, are mechanically coupled to each other and/or are mechanically connected to each other in such a manner that the two elements have an identical temperature, in particular in the region of a bridge providing the isothermal connection or of a binding element providing the isothermal connection. Thus, no heat transition by means of heat conduction takes place between the two elements since a temperature profile from one element to the other is constant.

A rotary machine can comprise a soft-magnetic rotor body which has a multiplicity of soft-magnetic pole bodies on a soft-magnetic carrying body (yoke). For example, iron, steel, nickel-iron alloys or cobalt-iron alloys can be used as the soft-magnetic material. Two windings are positioned adjacently to each other between every two soft-magnetic pole bodies. A spacer region in the form of a groove can be formed between two soft-magnetic pole bodies. Pole bodies can be designed as pole teeth or as a pole shoe/pole core combination.

Individual vacuum containers and pairs of vacuum containers in a rotor body can have outer and inner radii with respect to the axis of rotation of said rotor body.

According to certain embodiments, it has been recognized that, in an arrangement of cold windings about a rotor body which is at room temperature—specifically with one magnetic pole body per winding—adjacent windings can be directly supported on one another. Therefore, in the best case, namely in which all of the forces occurring in an opposite direction can be directly compensated for with corresponding cold isothermal connections, advantageously only the actually occurring net forces have to be transmitted between cold winding system and warm rotor iron. The actually occurring net forces include, for example, that portion of the nominal torque which is allotted to winding system and rotor body. According to some embodiments, correspondingly reduced material cross sections are permitted for the cold-warm connections still required for this purpose or supporting elements with a correspondingly lower heat load. As a direct advantageous result, capital expenditure on the associated cooling technology and the operating costs thereof is reduced. According to some embodiments, it is proposed to connect the conventionally topologically separated vacuum containers of individual windings, i.e. separate individual vacuum containers, of a rotating synchronous machine with rotor windings composed of high temperature superconductors (HTS) and warm pole bodies to one another for the purpose of direct support with suitable openings for traction and/or support connections. Depending on the specific design, this gives rise either to a multiplicity of individual connections, or, if the hitherto separate individual vacuum containers are completely connected in the direct active region of the windings, to a complicated shape of the entire vacuum container or vacuum vessel, specifically in the region of the winding heads.

Other embodiments provide a method for producing a rotary machine, e.g., a synchronous machine, is proposed, with cold superconducting windings positioned in a warm soft-magnetic rotor body, wherein two windings positioned adjacently to each other between every two adjacent soft-magnetic pole bodies are fastened by means of support elements in a common pair of vacuum containers in order to achieve thermal insulation, and the two windings are isothermally connected to each other at their two mutually facing sides by means of at least one common support and/or traction element.

Other embodiments provide a method for cooling a rotary machine is proposed, wherein the heat generated by regions of a soft-magnetic rotor body that are enclosed in an overall vacuum container is dissipated to an inner wall of a hollow cylinder by means of heat conduction and/or heat radiation.

According to one embodiment, all of the pairs of vacuum containers can be replaced by a common overall vacuum container or overall vacuum vessel by the latter enclosing or encompassing all of the pairs of vacuum container volumes and additionally at least parts of the soft-magnetic rotor body. It has advantageously been recognized that conventionally the warm magnetic iron, that is to say magnetic iron which is at room temperature or there above, or a soft-magnetic rotor body is attached outside the insulating vacuum for a cold winding. By means of the incorporation of the soft-magnetic material, for example iron, into the vacuum container space, the design of a conventional vacuum vessel is considerably simplified and permits simple vacuum containers. A required overall length of high-vacuum-tight brazed or welded connections is effectively smaller and therefore results in a more rapid and more cost-effective manufacturing in comparison to the prior art. Such advantages are particularly effective in the case of multipole rotary machines.

According to a further embodiment, the respective pair of vacuum containers can be produced by means of formation of a vacuum-tight connecting channel between the two individual vacuum containers each surrounding a winding, wherein the connecting channel receives the common support and/or traction element.

According to a further embodiment, the respective pair of vacuum containers can be produced by means of removal of two intermediate walls between the two individual vacuum containers each surrounding a winding, wherein the two resulting vacuum container parts have been connected to each other in a vacuum-tight manner.

According to a further embodiment, the overall vacuum container can be designed in the form of a hollow cylinder which has an outer wall and an inner wall and can be closed in the region of its basic surfaces by means of annular covers. According to a further advantageous refinement, the radius of the outer wall of the hollow cylinder can be identical or correspond to an outer radius of the pair of vacuum containers. The radius of the outer wall can be adapted here in such a manner that outer regions of pole bodies, in particular pole caps or pole shoes, are not contained in the overall vacuum container.

According to a further embodiment, the radius of the outer wall of the hollow cylinder can be identical or correspond to an outer radius of pole bodies of the rotor body. The outer wall of the hollow cylinder is provided here in such a manner that outer regions of pole bodies, in particular pole caps or pole shoes, are contained in the overall vacuum container.

According to a further embodiment, the radius of the inner wall of the hollow cylinder can correspond or be identical to an inner radius of the pair of vacuum containers. According to this embodiment, a yoke of soft-magnetic material or a soft-magnetic carrying body is not contained in the overall vacuum container.

According to a further embodiment, the radius of the inner wall of the hollow cylinder can correspond or be identical to an inner radius of a soft-magnetic carrying body of the rotor body.

According to this embodiment, a yoke of soft-magnetic material or a corresponding carrying body of the rotor body is contained in the overall vacuum container, which may also be referred to as an overall vacuum vessel.

According to a further embodiment, the heat generated by those regions of the soft-magnetic rotor body which are enclosed in the overall vacuum container can be dissipated from the outer wall of the hollow cylinder by means of air cooling. According to a further advantageous refinement, the heat generated by those regions of the soft-magnetic rotor body which are enclosed in the overall vacuum container can be dissipated by means of a closed circuit cooling which is arranged on the rotor body and has coolant in pipes reaching to the regions.

According to a further embodiment, the material of the overall vacuum container bordering the region of the soft-magnetic rotor body can be magnetic. The regions of the soft-magnetic rotor body may also be referred to as “sectioned”.

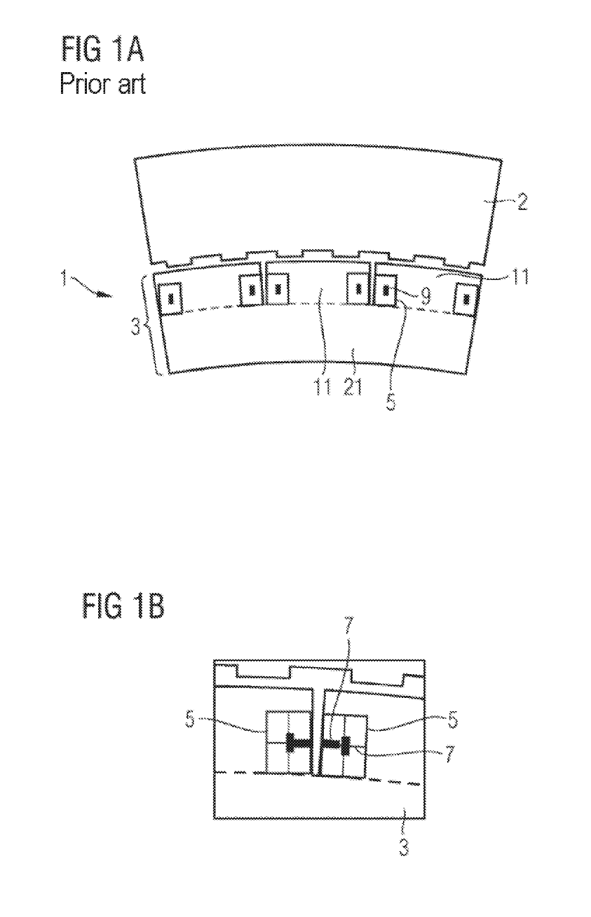

FIG. 1a shows an exemplary embodiment of a conventional rotary machine 1. The rotary machine 1 illustrated has a warm soft-magnetic rotor body 3 in which cold superconducting windings 9 are each positioned in a separate individual vacuum container 5 by means of support elements 7 in order to achieve thermal insulation (see FIG. 1b). The soft-magnetic rotor body 3 consists of a soft-magnetic carrying body 21, which may also be referred to as a yoke, and of pole bodies 11, which may also be produced from the soft-magnetic material. The stator of the rotary machine 1 is identified by the reference number 2.

FIG. 1b shows an enlarged portion from FIG. 1a with regard to two separate individual vacuum containers 5 which are positioned in the rotor body 3 and transmit forces of the windings 9 to the rotor body 3 by means of support elements 7 or support and/or traction elements 7.

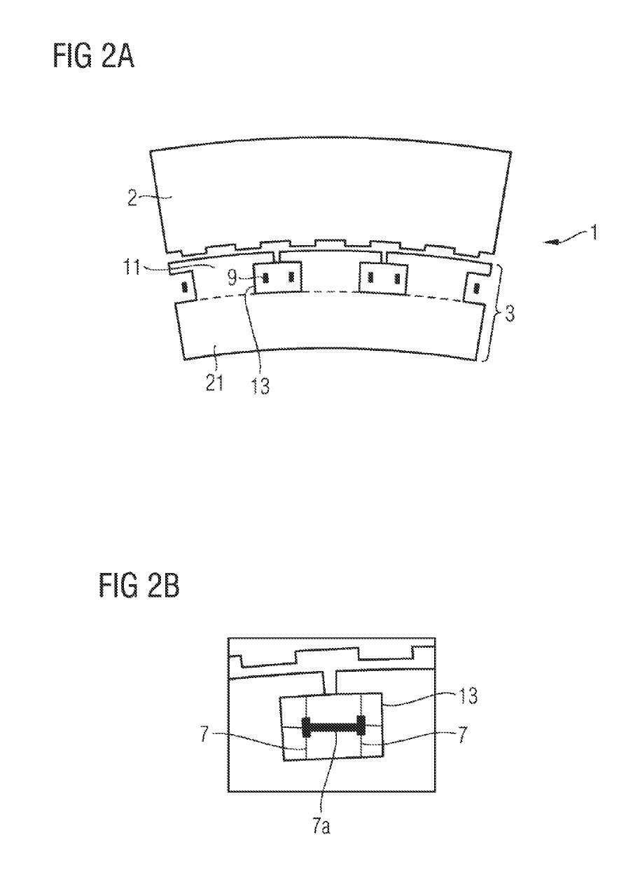

FIG. 2a shows a first exemplary embodiment according to the invention of a rotary machine 1. Identical elements to FIG. 1a denote identical elements of a rotary machine 1. In contrast to the prior art according to FIGS. 1a and 1b, a common pair of vacuum containers 13 is now produced for two windings 9 positioned adjacently to each other between every two soft-magnetic pole bodies 11. In addition, the two windings 9 are isothermally connected to each other at their two mutually facing sides by means of a common support and/or traction element 7a. This is shown in particular in FIG. 2b in which support elements 7 and 7a are illustrated.

FIG. 2a shows in particular that, in the case of synchronous machines 1 with a high number of poles, the magnetic forces of an individual winding 9 are directed during normal operation substantially toward the soft-magnetic material. A part of the winding 9 which is directly adjacent in the circumferential direction, which part is located in a common groove between two pole bodies 11, is subjected here to magnetic forces in virtually precisely the opposite direction.

According to the invention, the following has now been recognized: instead of merely supporting the forces in each case on the warm wall of an individual vacuum container 5 according to FIG. 1b, it is now proposed to connect the two cryogenic windings 9 in this region isothermally to each other with a common support and/or traction element 7a and to thereby completely omit the introduction of heat which previously occurred. All that is required for this purpose is to correspondingly connect the individual vacuum containers 5 which were hitherto separate for each individual winding 9.

Depending on the magnitude of the forces to be transmitted and the resulting system of isothermal connections, individual connections can be produced, for example, by corresponding openings in the two warm walls of original individual vacuum containers 5 which can be connected, again in a vacuum-tight manner, to, for example, a connecting pipe.

FIG. 2b shows a further alternative in which a supporting of two adjacent winding parts 9 of different windings 9 is of advantage, wherein the double warm wall between the original individual vacuum containers 5 is completely omitted, and wherein the vacuum vessel parts or vacuum container parts produced have to be connected at a suitable point, again in a correspondingly vacuum-tight manner. The latter can be realized in particular by means of suitable welding parts.

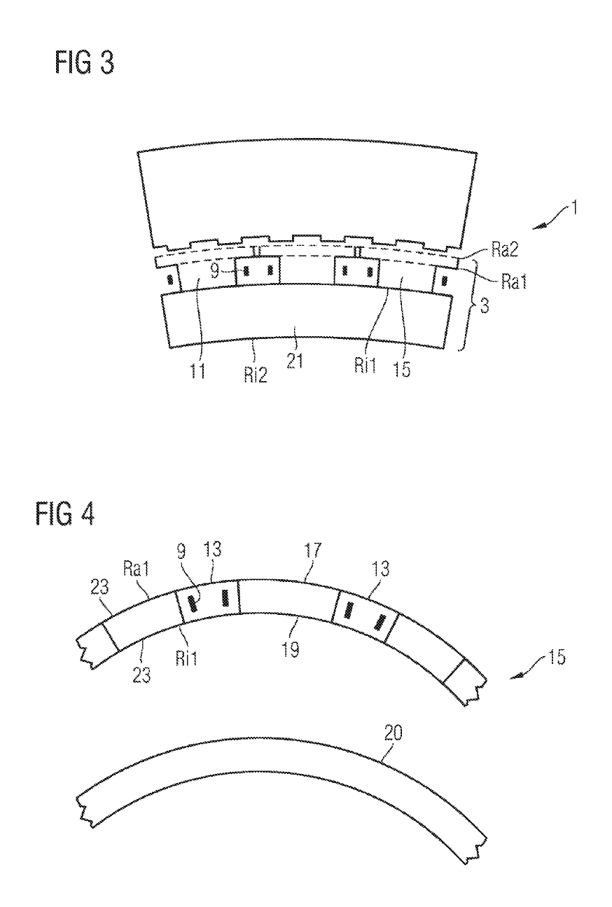

FIG. 3 shows a second exemplary embodiment of a rotary machine 1 according to the invention. FIG. 3 shows that all of the pairs of vacuum containers 13, for example according to FIG. 2a, can be replaced by a common overall vacuum container 15. This can take place by the common overall vacuum container 15 which is to be formed enclosing all of the pairs of vacuum container volumes 13 and furthermore at least parts of the soft-magnetic rotor body 3. A particular refinement is an overall vacuum container 15 in the form, which is illustrated in FIG. 4, of a hollow cylinder which has an outer wall 17 and an inner wall 19 and can be closed in the region of its basic surfaces by means of annular covers 20. The radius Ra1 of the outer wall 17 of the hollow cylinder is matched to an outer radius of the pair of vacuum containers 13. According to FIG. 4, the radius Ri1 of the inner wall 19 of the hollow cylinder corresponds to an inner radius of the pair of vacuum containers 13. According to FIG. 4, an exemplary embodiment according to the invention of an overall vacuum container 15 is illustrated, in which a carrier body 21 or yoke and outer regions of pole bodies 11, in particular pole caps or pole shoes, are not contained in the overall vacuum container 15.

FIG. 3 additionally illustrates a further exemplary embodiment, in which a radius Ra2 of the outer wall 17 of the hollow cylinder according to FIG. 4 is additionally illustrated, the radius being identical to an outer radius of pole bodies 11 of the rotor body 3. FIG. 3 also illustrates the embodiment in which the radius Ri2 of the inner wall 19 of the hollow cylinder according to FIG. 4 corresponds to an inner radius of a carrying body 21 of the rotor body 3. According to this embodiment, outer regions of the pole bodies 11 and the carrying body 21 are contained in the overall vacuum container 15. In FIG. 3, the radius Ra1 and the radius Ra2 are illustrated as dashed lines.

FIG. 4 illustrates a graphical simplification of the illustration according to FIG. 3. FIG. 4 additionally shows that an overall vacuum container 15 is closeable in the region of its basic surface by means of annular covers 20.

FIG. 4 shows that, when the warm soft-magnetic material is at least partially placed within the vacuum container, a considerable simplification in the design of the vacuum container is possible. For example, a double-walled hollow cylinder can be topologically produced, said hollow cylinder either having been flange-mounted at both ends with annular covers or closed with comparatively short weld seams.

The material for the vacuum wall in the regions in which the soft-magnetic rotor material has been “sectioned” can advantageously be manufactured from a magnetic material in order to keep the length of the magnetic air gap as small as possible.

FIG. 5 shows an exemplary embodiment of a method according to the invention for producing a rotary machine 1. Cold superconducting windings 9 are intended to be positioned in a warm soft-magnetic rotor body 3 by means of supporting elements 7. For this purpose, respective pairs of vacuum containers 13 can be produced from individual vacuum containers 5, which have originally already been formed (step S1). With a second step S2, two windings 9 positioned adjacently to each other can be fastened between every two soft-magnetic pole bodies 11 in a respective common pair of vacuum containers 13 by means of support elements 7. With a third step S3, the two windings 9 can be connected isothermally to each other at their two mutually facing sides by means of a common support and/or traction element 7a.

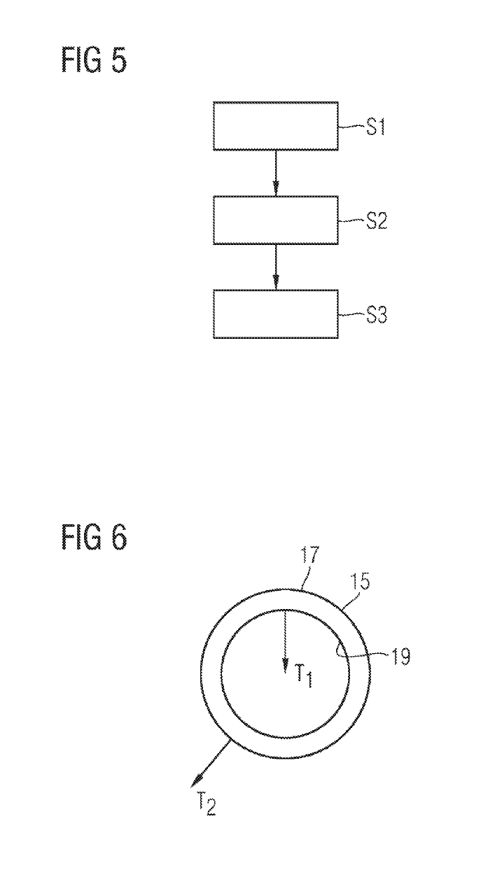

FIG. 6 is an illustration of the cooling of a rotary machine 1 during its operation. T1 illustrates that the heat generated by regions of a soft-magnetic rotor body 3 that are enclosed in an overall vacuum container 15 is dissipated to an inner wall 19 of a hollow cylinder by means of heat conduction and/or heat radiation.

T2 illustrates that the heat generated by those regions of the soft-magnetic rotor body 3 which are enclosed in the overall vacuum container 15 is dissipated from an outer wall 17 of the hollow cylinder by means of air cooling. Cooling can likewise be dissipated by means of a closed circuit cooling (not illustrated) which is arranged on the rotor body 3 and has coolants in pipes reaching to the regions.

FIG. 6 shows that the warm soft-magnetic material stored in the vacuum space should be able to suitably remove the heat which arises there and which

results, for example, from the iron losses or possible damping rods and the like. Depending on the magnitude of said losses, said heat removal can be realized, for example, by means of heat conduction and/or heat radiation to the inner vacuum wall 19, followed by, for example, air cooling on the outer side of the vacuum vessel. A further embodiment is an active or passive closed circuit cooling which is arranged on the rotor body 3 and has coolant in pipes which reach into or to the vacuum space and therefore to the soft-magnetic material to be cooled and transport the heat arising there out of the insulated region and output same at another location.

What is claimed is:

1. A rotary machine, comprising:
a warm soft-magnetic rotor body including a plurality of soft-magnetic pole bodies, and
a pair of cold superconducting windings positioned adjacent to each other between each adjacent pair of soft-magnetic pole bodies,
wherein each pair of windings is fastened by support elements in a common pair of vacuum containers to provide thermal insulation, and
wherein each pair of windings are isothermally connected to each other at mutually facing sides by at least one common support or at least one traction element.

2. (canceled)

3. The rotary machine of claim 1, comprising at least one vacuum-tight connecting channel between each common pair of vacuum containers, wherein each connecting channel includes at least one common support or traction element.

4. The rotary machine of claim 1, wherein each pair of vacuum containers is produced by removal of two intermediate walls between two individual vacuum containers to define two vacuum container parts connected to each other in a vacuum-tight manner.

5-13. (canceled)

14. A method for producing a rotary machine, the method comprising:
forming a warm soft-magnetic rotor body including a plurality of soft-magnetic pole bodies;
forming a pair of cold superconducting windings positioned adjacent to each other between each adjacent pair of soft-magnetic pole bodies,
fastening each pair of windings by support elements and enclosing each pair of windings in a common pair of vacuum containers to provide thermal insulation,
wherein each pair of windings are isothermally connected to each other at mutually facing sides by at least one common support or traction element.

15. (canceled)

16. The method of claim 14, wherein each pair of vacuum containers is produced formation of at least one vacuum-tight connecting channel between two individual vacuum containers each surrounding a winding, wherein each connecting channel receives at least one common support or traction element.

17. The method of claim 14, wherein each pair of vacuum containers is produced by removal of two intermediate walls between two individual vacuum containers each surrounding a winding to define two vacuum container parts connected to each other in a vacuum-tight manner.

18. The method of claim 14, wherein the overall vacuum container comprises a hollow cylinder having an outer wall and an inner wall and having basic surfaces closed by annular covers.

19-21. (canceled)

22. A rotary machine, comprising:
a warm soft-magnetic rotor body including a plurality of soft-magnetic pole bodies,
a plurality of cold superconducting windings,
a pair of the windings are positioned adjacent to each other between each adjacent pair of soft-magnetic pole bodies, and
a common vacuum container enclosing all pairs of windings and at least parts of the soft-magnetic rotor body.

23. The rotary machine of claim 22, wherein:
each pair of windings is contained in a respective pair of vacuum container portions;
the common vacuum container encloses the pairs of vacuum container portions; and
the common vacuum container comprises a hollow cylinder having an outer wall and an inner wall and having basic surfaces closed by annular covers.

24. The rotary machine of claim 23, wherein the outer wall of the hollow cylinder has a radius corresponding to an outer radius of a respective pair of vacuum container portions.

25. The rotary machine of claim 24, wherein the radius of the outer wall of the hollow cylinder corresponds to an outer radius of the pole bodies of the rotor body.

26. The rotary machine of claim 24, wherein the inner wall of the hollow cylinder has a radius corresponding to an inner radius of a respective pair of vacuum container portions.

27. The rotary machine of claim 24, wherein the inner wall of the hollow cylinder has a radius corresponding to an inner radius of a carrying body of the rotor body.

28. The rotary machine of claim 23, wherein heat generated by regions of the soft-magnetic rotor body enclosed in the common vacuum container is dissipated to the inner wall of the hollow cylinder by at least one of conduction or radiation.

29. The rotary machine of claim 23, wherein heat generated by regions of the soft-magnetic rotor body enclosed in the common vacuum container is dissipated from the outer wall of the hollow cylinder via air cooling.

30. The rotary machine of claim 23, wherein heat generated by regions of the soft-magnetic rotor body enclosed in the common vacuum container is dissipated by a closed circuit cooling that is arranged on the rotor body and which includes coolant in pipes reaching to the regions.

31. The rotary machine of claim 23, wherein a region of the common vacuum chamber bordering the soft-magnetic rotor body is formed from a magnetic material.
